(19) United States
(12) Patent Application Publication
(10) Pub. No.: US 2026/0001242 A1
(43) Pub. Date: Jan. 1, 2026

(54) MEMBER FOR WIRING WIRE-BODY, STRUCTURE FOR WIRING WIRE-BODY, AND METHOD OF WIRING WORK FOR WIRE-BODY

(71) Applicant: FANUC CORPORATION, Minamitsuru-gun, Yamanashi (JP)

(72) Inventor: Xing GENG, Yamanashi (JP)

(73) Assignee: FANUC CORPORATION, Minamitsuru-gun, Yamanashi (JP)

(21) Appl. No.: 18/992,615

(22) PCT Filed: Aug. 26, 2022
(86) PCT No.: PCT/JP2022/032159

§ 371 Date: Jan. 9, 2025

(51) Int. Cl. B25J 19/00; B25J 9/00

(52) U.S. Cl. CPC B25J 19/0029; B25J 9/0009

(57) ABSTRACT

A member for wiring wire-body, which is used for wiring a plurality of wire bodies penetrating a hollow portion arranged between a first member and a second member which relatively rotate about a predetermined axis line, the hollow portion is arranged along the axis line, and one sides of the wire-bodies are held by the first member and the other sides are held by the second member. The member for wiring wire-body includes a sheet-like first portion, and a second portion which fixes the first portion to the first member or the second member, wherein the first portion is arranged in the hollow portion to partition a space in the hollow portion into two small spaces or more in a direction crossing the axis line, and wherein each of the partitioned small spaces is configured to allow the one or more of the wire-bodies to pass therethrough.

This application is a national phase of International Application No. PCT/JP2022/032159 filed Aug. 26, 2022, which is incorporated herein by reference in its entirety.

### TECHNICAL FIELD

The present disclosure relates to a member for wiring wire-body, structure for wiring wire-body, and a method of wiring work for wire-body.

### BACKGROUND ART

A wiring apparatus for arranging a wire body at a position located between two members of a robot which rotates relative to each other around a predetermined axis line of the robot is known (for example, see PTL 1).

In this wiring device, a pipe member having a double structure in which an inner pipe member and an outer pipe member having different diameters from each other are concentrically arranged is arranged concentrically with an axial center of the relative rotation. Further, a wire body of a first group is passed through a hollow portion of the inner pipe member and a wire body of a second group is passed through a gap between the inner pipe member and the outer pipe member, thereby preventing abnormal wear due to friction occurs between the wire-bodies.

### Citation List

### Patent Literature

Japanese Unexamined Patent Application, Publication No. 2004-276233

### SUMMARY

An aspect of the present disclosure is a member for wiring wire-body, wherein the member is used for wiring a plurality of wire bodies penetrating a hollow portion arranged between a first member and a second member which rotate relative to each other about a predetermined axis line, the hollow portion is arranged along the predetermined axis line, and one sides in a length direction of the wire-bodies are held by the first member and the other sides are held by the second member, wherein the member for wiring wire-body includes: a sheet-like first portion; and a second portion which fixes the first portion to the first member or the second member, wherein the first portion is arranged in the hollow portion so as to partition a space in the hollow portion into two small spaces or more in a direction crossing the axis line, and wherein each of the partitioned small spaces is configured to allow the one or more of the wire-bodies to pass therethrough.

### BRIEF DESCRIPTION OF DRAWINGS

FIG. 1 is a schematic longitudinal cross sectional view showing structure for wiring wire-body according to an embodiment of the present disclosure.

FIG. 2 is a perspective view showing an example of a member for wiring wire-body according to an embodiment of the present disclosure.

FIG. 3 is a perspective view showing a state in which an intermediate position in a length direction of a wire body is arranged along a first portion of the member for wiring wire-body of FIG. 2.

FIG. 4 is a perspective view showing a process for rolling the first portion of the member for wiring wire-body of FIG. 2 into a cylindrical shape.

FIG. 5 is a perspective view showing a state in which the first portion of FIG. 4 is rolled into a cylindrical shape and bound.

FIG. 6 is a lateral cross sectional view showing small spaces which are partitioned in an internal space of a hollow member in the structure for wiring wire-body of FIG. 1.

FIG. 7 is a perspective view showing a modified example of the member for wiring wire-body of FIG. 2.

FIG. 8 is a perspective view showing a structure for wiring wire-body in which the member for wiring wire-body of FIG. 7 is assembled to the hollow member.

FIG. 9 is a lateral cross sectional view showing small spaces which are partitioned in the internal space of the hollow member in the structure for wiring wire-body of FIG. 8.

FIG. 10 is a lateral cross sectional view showing a modified example of FIG. 9.

FIG. 11 is an exploded perspective view showing a modified example of the structure for wiring wire-body of FIG. 8.

FIG. 12 is a perspective view showing the structure for wiring wire-body of FIG. 11.

### DESCRIPTION OF EMBODIMENTS

When an inner pipe member is concentrically fixed to an inner side of an outer pipe member, it is necessary to form the inner pipe member to have high rigidity and to firmly fix the inner pipe member to the inner side of the outer pipe member so that the inner pipe member is not deformed or displaced by force received from the wire bodies which pass through the inner pipe and the space between the inner pipe and the outer pipe. However, since the internal space of the robot is limited, when the thickness of the inner pipe member is increased in order to increase its rigidity, the space through which the wire-bodies pass is narrowed. In addition, the space inside the outer pipe member is also narrowed depending on a fixing member used for firmly fixing the inner pipe member to the outer pipe member.

Therefore, it is desired to perform wiring without excessively narrowing the space inside the hollow portion through which the wire-bodies pass and without causing abnormal wear to the plurality of wire-bodies.

A member for wiring wire-body, structure for wiring wire-body, and a method of wiring work for wire-body according to a first embodiment will be described with reference to the drawings.

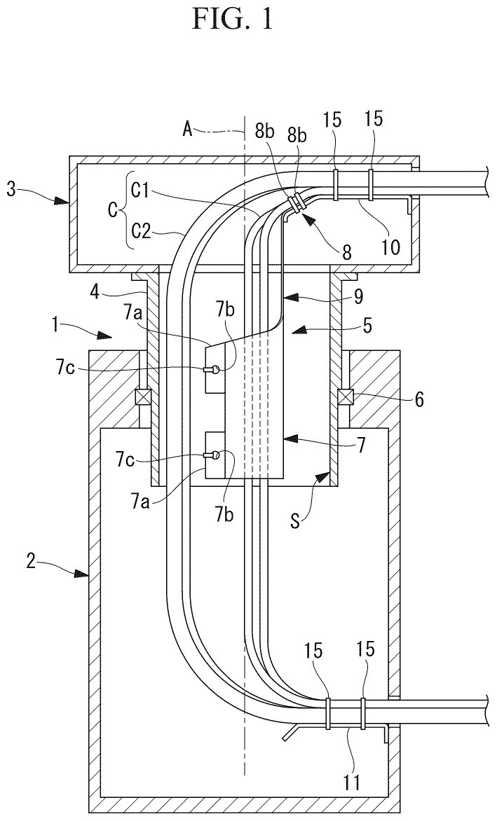

As shown in FIG. 1, wire-body wiring structure (structure for wiring wire-body) 1 according to the present embodiment is structure for wiring a wire-body C wired between two members of a robot which rotates relative to each other around a vertical axis line A of the robot, for example. The two members of the robot are a fixed-side housing (a first member) 2 and a movable-side housing (a second member) 3 which are placed one above the other, for example.

The wire-body C includes at least one of a structural cable, a signal cable, or a long bendable wire-like member such as an air tube. The wire-body wiring structure 1 according to the present embodiment is structure for wiring two or more types of wire bodies C such as a thin and flexible cable C1 (having a small bending radius) and a thick and hard air tube C2 (having a large bending radius), and the like, for example. They will also be referred to as the wire-bodies C1, C2 from hereon.

The wire-body wiring structure 1 is provided with a cylindrical hollow member 4 which is fixed to the movable-side housing 3 and a wire-body wiring member (member for wiring wire-body) 5 at least a part of which is arranged in an internal space (a hollow portion) S of the hollow member 4. The hollow member 4 is arranged so that its central axis is aligned with the axis line A and is supported by the fixed-side housing 2 by means of a bearing 6 so as to be rotatable around the axis line A.

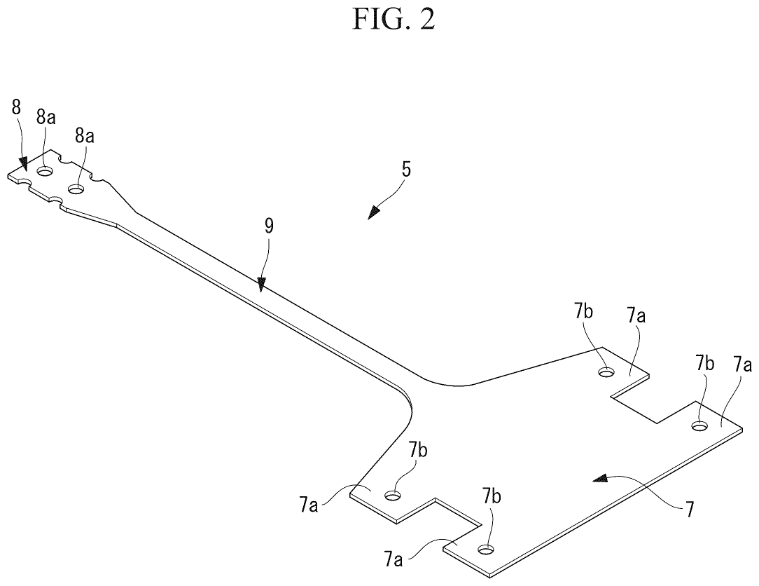

As shown in FIG. 2, the wire-body wiring member 5 according to the present embodiment is formed using a flexible sheet-like material made of a low-friction material. As the material, a sheet made of a polytetrafluoroethylene resin having a thickness of 1 mm or less, for example, a thickness of 0.5 mm can be adopted. The wire-body wiring member 5 is integrally manufactured by cutting out from the sheet-like material. Also, as the wire-body wiring member 5, any low-friction material other than the one made of the polytetrafluoroethylene resin or any other material may be adopted.

The wire-body wiring member 5 is provided with a first portion 7 formed in a home base shape having a predetermined width dimension and length dimension, and a second portion 8 which is arranged at a position spaced apart from the first portion 7 in the length direction. Also, the wire-body wiring member 5 is provided with a long band-like third portion 9 which connects the first portion 7 and the second portion 8 and has a certain width dimension which is sufficiently smaller than the first portion 7.

By forming the first portion 7 in the shape of the home base, an angle of a connection portion of the first portion 7 and the third portion 9 is formed to be an obtuse angle, and stress concentration can be reduced.

The first portion 7 is provided with two tabs 7a at each of both ends in the width direction. Each tab 7a is provided with a through hole 7b penetrating the tab in the thickness direction.

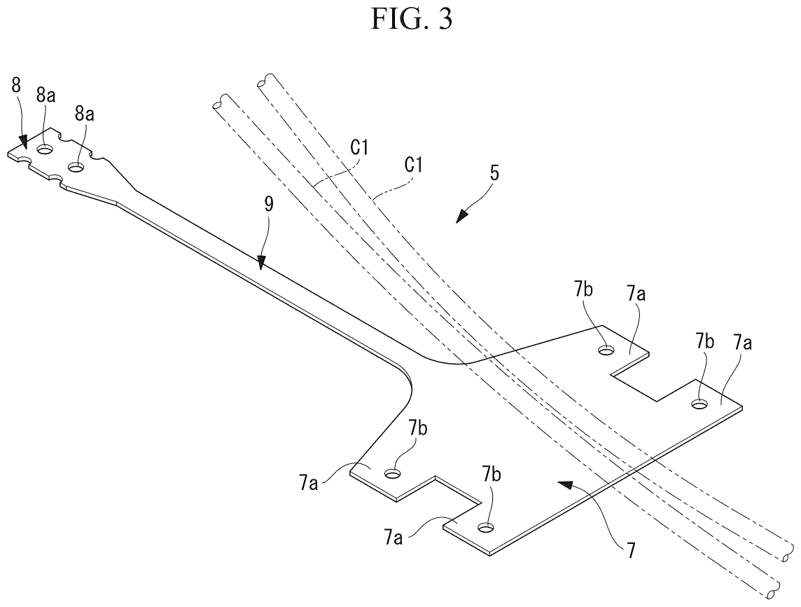

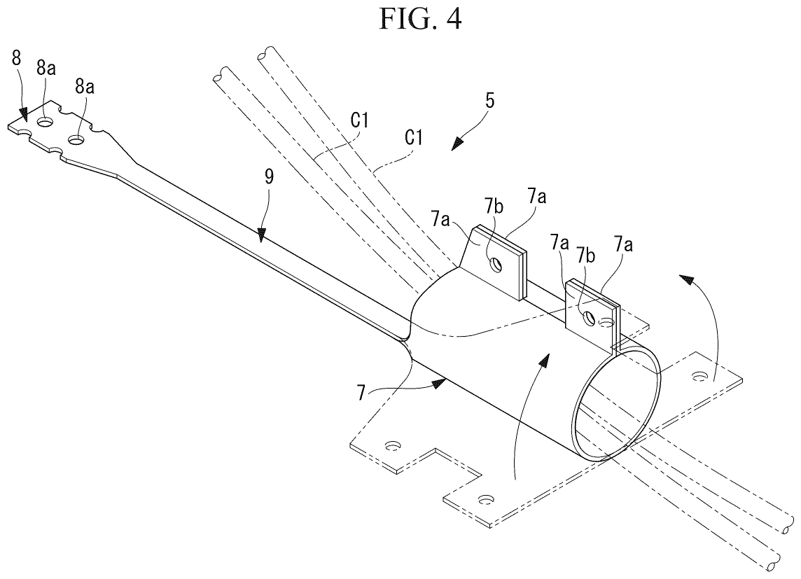

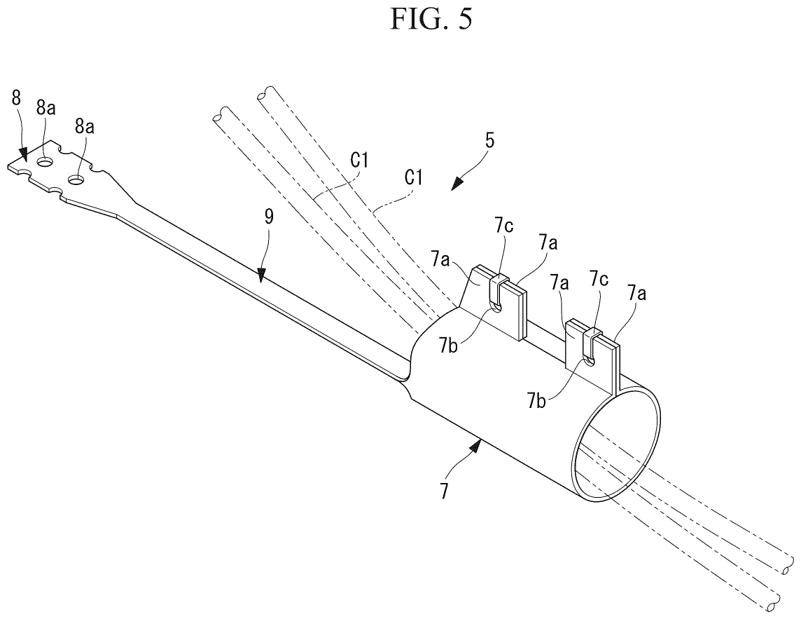

As shown in FIG. 3, in a state in which an intermediate position of the wire-body C1 in a longitudinal direction is arranged so as to be aligned with the first portion 7, the first portion 7 is formed into a cylindrical shape by being rolled in one direction around the axis line along the longitudinal direction, as shown in FIG. 4. Also, as shown in FIG. 5, the first portion 7 is formed into a closed cylindrical shape by aligning the tabs 7a provided at the both ends in the width direction and by fastening cable ties 7c penetrating the through holes 7b of the both tabs 7a, for example.

The first portion 7 has a width dimension capable of surrounding one or more wire-bodies C1 which are arranged in the inside so that the wire-bodies C1 are spaced apart from each other in the radial direction when the first portion 7 is formed into the cylindrical shape. Also, the length dimension of the first portion 7 is set to be equal to or smaller than the length dimension of the hollow member 4, for example.

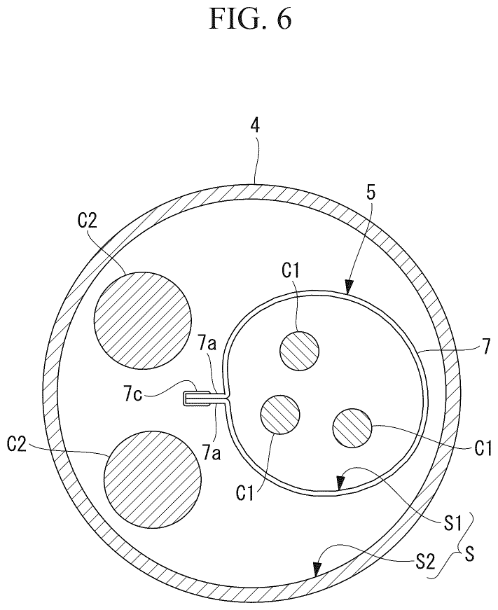

The first portion 7 is arranged at a position in the hollow member 4 in a state in which the first portion 7 is closed into the cylindrical shape so as to surround some wire-bodies C1 among the plurality of wire-bodies C passing through the hollow member 4. As a result, as shown in FIG. 6, in a range of the length dimension of the first portion 7, the space S in the hollow member 4 is partitioned into a first small space S1 surrounded by the first portion 7 and a second small space S2 located at a position between the hollow member 4 and the first portion 7.

As shown in FIGS. 2 to 5, the second portion 8 is formed to have a width dimension larger than the third portion 9, and the second portion 8 includes a plurality of through holes 8a penetrating the second portion in the thickness direction. The second portion 8 can be fixed to, for example, a sheet metal 10 and the like which is fixed to the movable-side housing 3 by means of the cable ties 8b at a position located above the hollow member 4 by using the through holes 8a, for example.

The third portion 9 is a portion for maintaining the first portion 7 to stay at a certain position with respect to the fixed second portion 8, and the third portion 9 has flexibility and is deformed easily by force applied by the wire-body C to change positions of the first portion 7 in response to the position of the wire-body C.

A method of wiring work for wire-body using the member for wiring wire-body 5 and the structure 1 for wiring the wire-body according to the present embodiment, which are configured as described above, will be described below.

The method of wiring work for wire-body according to the present embodiment is a method for wiring the plurality of wire-bodies C penetrating through the internal space S of the hollow member 4 in the vertical direction, and the internal space S of the hollow member 4 is arranged in the vertical direction between the fixed-side housing 2 and the movable-side housing 3 which relatively rotate with each other around a vertical axis line A.

Each of the wire-bodies C includes the plurality of the thin and flexible cables C1 (having a small bending radius) and the plurality of the thick and hard air tubes C2 (having a large bending radius). The number of cables Cl and the air tubes C2 may be any number of one or more. Also, instead of or in addition to the air tube C2, the wire bodies C may include a thick and hard cable (having a large bending radius) (not show).

The one sides in the length direction of the wire-bodies C are held by a sheet metal 11 fixed to the fixed-side housing 2 by using cable ties 15 and the other sides in the length direction of the wire-bodies C are held by a sheet metal 10 fixed to the movable-side housing 3 using cable ties 15.

In this embodiment, the first portion 7 of the wire-body wiring member 5 is rolled into the cylindrical shape and the both ends in the width direction are bound so as to surround the plurality of thin flexible cables C1. Further, the band-like third portion 9 is extended upward, and at a position located outside the hollow member 4, the second portion 8 arranged at the distal end is fixed to the sheet metal 10 fixed to the movable-side housing 3 by means of the cable ties 8b.

As a result, the first portion 7 is suspended by the third portion 9 hanging from the second portion 8, and is arranged at a position in the internal space S of the hollow member 4. A space arranged at a position in the length direction of the first portion 7 is partitioned into a first small space S1 surrounded by the first portion 7 and an annular second small space S2 arranged at a position between the hollow member 4 and the first portion 7.

That is, the plurality of thin and flexible cables C1 penetrates the hollow member 4 at a position in the radial direction penetrating the first small space S1. Also, the plurality of thick and hard air tubes C2 penetrates the hollow member 4 at a position in the radial direction penetrating the second small space S2.

With the wire-body wiring member 5, the wire-body wiring structure 1, and the method of wiring work for wire-body according to the present embodiment, the internal space S of the hollow member 4 through which the wire-bodies C penetrate is partitioned into the plurality of small spaces S1, S2 by the flexible sheet-like wire-body wiring member 5. The flexible sheet-like wire-body wiring member 5 can be formed to be thin so that the wire-body wiring member 5 can partition the internal space S of the hollow member 4 into the plurality of small spaces S1, S2 without narrowing the internal space S of the hollow member 4 in comparison with a case of using a pipe material having high rigidity.

Further, with the wire-body wiring structure 1 according to the present embodiment, the second portion 8 is fixed to the upper sheet metal 10 located at a position outside the hollow member 4, and the first portion 7 is suspended in the hollow member 4 by means of the third portion 9. In this way, the second portion 8 for fixing the wire-body wiring member 5 is not arranged inside the hollow member 4, and therefore, the internal space S of the hollow member 4 can be prevented from being narrowed by the second portion 8.

As a result, a wide space can be obtained in which the different wire-bodies C1, C2 passing thorough the different small spaces S1, S2 can change their positions in accordance with the rotation of the movable-side housing 3 with respect to the fixed-side housing 2. That is, it is possible to reduce load applied to the wire-bodies C without excessively restricting movement of the wire-bodies C which are displaced in the hollow member 4.

The wire bodies C are held by the fixed-side housing 2 on the one side in the length direction and by the movable-side housing 3 on the other side. Accordingly, when the movable-side housing 3 is rotated around the axis line A with respect to the fixed-side housing 2, the wire-bodies C passing through the inside of the hollow member 4 are also twisted and bent, and the positions of the wire-bodies C are changed in the hollow member 4.

According to the present embodiment, the first portion 7 is displaced and deformed in accordance the displacement of the wire-bodies C since the first portion 7 surrounding the cable Cl is suspended by the band-like flexible third portion 9. And, the different wire-bodies C1, C2 are maintained in a state of being separated. As a result, it is possible to prevent the wire bodies C1, C2 passing through the different small spaces S1, S2 from being strongly rubbed against each other.

That is, the thin and flexible cable C1 surrounded by the first portion 7 can be prevented from being strongly pushed against the outer surface of the thick and hard air tube C2 arranged at the position outside the first portion 7, and abnormal wear of the cable Cl can be suppressed. In particular, by forming the wire-body wiring member 5 using a low friction material, it is possible to effectively suppress the wire-bodies C1, C2 passing through the different small spaces S1, S2 from being rubbed against each other.

Moreover, the wire-body wiring member 5 according to the present embodiment is capable of surrounding the wire-body C1 at the intermediate position in the length direction by rolling the first portion 7, which is open in a flat manner, and forming it into the cylindrical shape.

Accordingly, even when a connecter (not shown) is attached to the distal end of the wire-body C1, the intermediate position of the wire-body C1 in the length direction can easily be surrounded by the first portion 7 in the cylindrical shape having a smaller diameter than the connecter. That is, it is possible to apply the first member 7 easily to a mechanism portion in which the size of the internal space S of the follow member 4 is limited, such as small robots or wrist units, without preparing a cylindrical member having a large inner diameter through which the connecter can pass.

Note that, in the present embodiment, the cable C1 having the small bending radius is surrounded by the first portion 7 of the wire-body wiring member 5 so as to be separated from the air tube C2 having the large bending radius, which is arranged at the position located outside the first portion 7. Alternatively, when there is the plurality of wire-bodies C having large surface friction, one of the wire-bodies C may be surrounded by the first portion 7 so that the wire bodies C can pass through the different small spaces S1, S2.

Also, in the present embodiment, the internal space S is partitioned into the two small spaces S1, S2 by arranging one first portion 7 in the internal space S of the hollow member 4, however, the inner space S may be partitioned into three or more small spaces by arranging two or more first portions 7.

Further, in the present embodiment, the sheet-like first portion 7 is rolled into the cylindrical shape so that some of the wire-bodies C1 are surrounded by the first portion 7, however, it is not limited to this. Moreover, although the present embodiment exemplifies a case in which the second portion 8 is fixed to the sheet metal 10 at the position above and outside the hollow member 4, the second portion 8 may be fixed to the hollow member 4 instead.

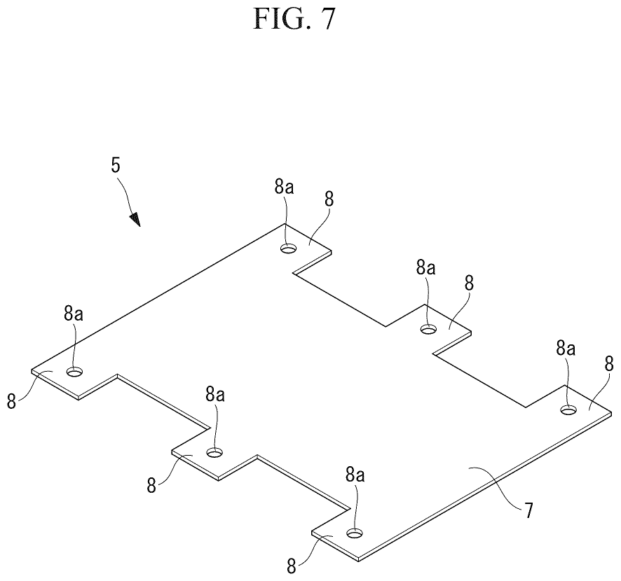

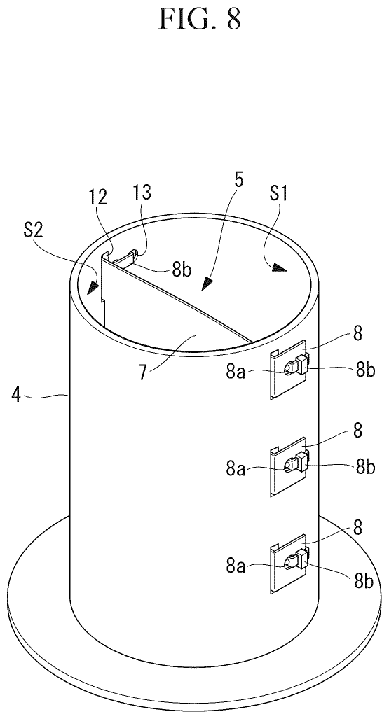

That is, as shown in FIG. 7, the wire-body wiring member 5 may include a flexible, rectangular, and sheet-like first portion 7 and tab-like second portions 8 protruding from both ends in the width direction of the first portion 7. And, as shown in FIG. 8, the second portions 8 may be fixed to the hollow member 4 by means of the cable ties 8b, for example, by using holes 12, 13 penetrating the hollow member 4 in the radial direction.

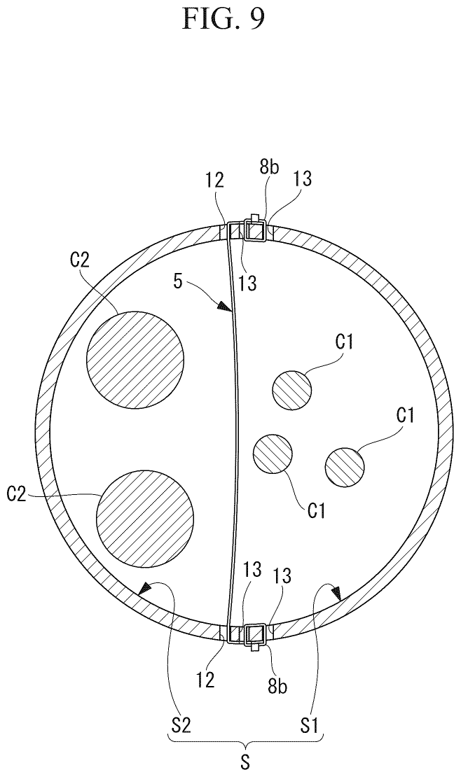

In this case, the form of the wire-body wiring member 5 can be changed depending on the positions of the holes 12, 13 provided in the hollow member 4. For example, as shown in FIG. 9, the wire-body wiring member 5 may be arranged in a flat diaphragm shape at a position inside the hollow member 4 so as to partition the internal space S of the hollow member 4 into the two small spaces S1, S2 having a semicircular cross-sectional surface.

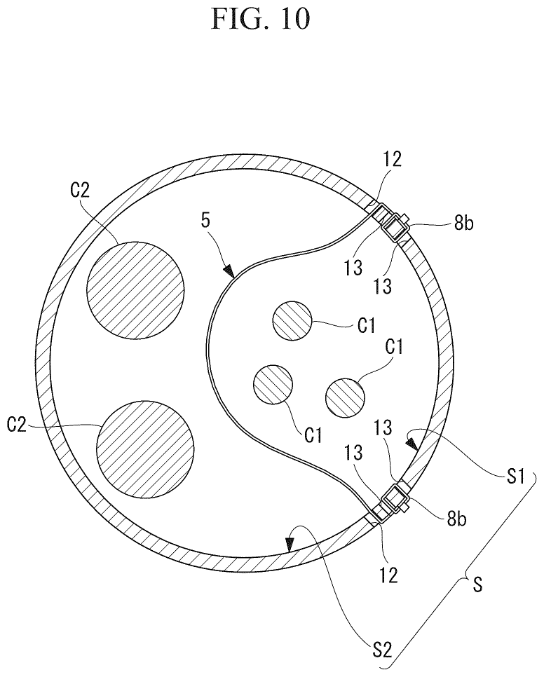

In addition, for example, as shown in FIG. 10, the wire-body wiring member 5 may be arranged in a curved diaphragm shape at a position located inside the hollow member 4 so as to partition the internal space S into the two small spaces S1, S2 having different cross-sectional surface shapes. Also, the internal space S of the hollow member 4 may be partitioned into three or more small spaces by using two or more wire-body wiring members 5.

Also, instead of fixing the second portion 8 to the sheet metal 10 at the position above and outside the hollow member 4, the second portion 8 may be fixed to the wire-body C2, such as a thick and hard air tube and the like, by means of a cable tie (not shown), for example. In this case, the second portion 8 may be positioned inside the hollow member 4.

Moreover, the length of the first portion 7 is formed to be smaller than the length of the hollow member 4, however, the length of the first portion 7 may be equal to or greater than the length of the hollow member 4.

In addition, although the first portion 7, the second portion 8, and the third portion 9 are integrally cut out from the same sheet-like material, instead of this, the first portion 7, the second portion 8, and the third portion 9 may be formed of different materials and may be bonded to each other to form the wire-body wiring member 5.

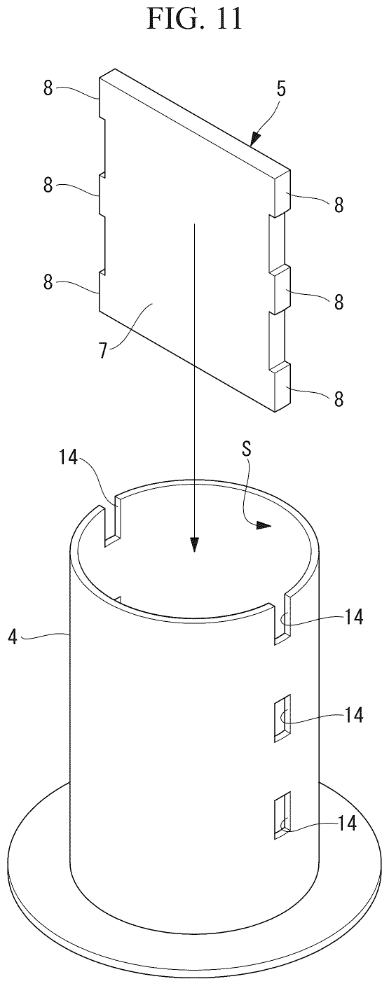

Moreover, in the present embodiment, at least the first portion 7 is formed in a flexible sheet-like shape, however, it is not limited to this. As shown in FIG. 11, the wire-body wiring member 5 may be formed in an elastically deformable and relatively thick sheet-like shape which is made of a low friction material such as tetrafluoroethylene resin, for example.

In the example shown in FIG. 11, the wire-body wiring member 5 has the rectangular and flat plate-like first portion 7 and the second portions 8 protruding outward in the width direction at both edges in the width direction of the first portion 7. Further, the hollow member 4 has the through hole 14 penetrating in the radial direction.

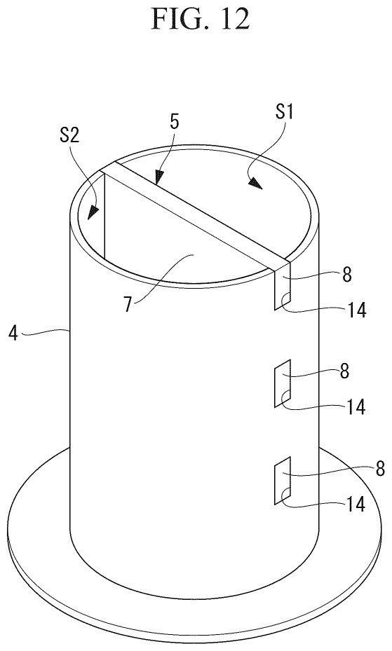

The first portion 7 of the wire-body wiring member 5 is elastically deformed slightly and inserted into the hollow member 4, and the second portion 8 is fitted into the through hole 14 by restoring the elastic deformation. As a result, as shown in FIG. 12, the internal space S of the hollow member 4 can be partitioned into the two small spaces S1, S2.

While the embodiments of this disclosure are described, it is not limited to the individual embodiments described above. Various additions, substitutions, changes, partial deletions, and the like can be made in these embodiments within a range not departing from the gist of the invention, or within a range not departing from the concept and purport of the invention derived from the contents described in the claims and equivalents thereof. For example, in the above described embodiment, the order of operations, the order of wiring, the omission or addition of some operations according to conditions, and the omission or addition of some wiring according to conditions can be performed without being limited to the above described example. Also, the same applies to the case where numerical values or mathematical expressions are used in the description of the above described embodiment.

1. A member for wiring wire-body, wherein the member is used for wiring a plurality of wire bodies penetrating a hollow portion arranged between a first member and a second member which rotate relative to each other about a predetermined axis line, the hollow portion is arranged along the predetermined axis line, and one sides in a length direction of the wire-bodies are held by the first member and the other sides are held by the second member,
wherein the member for wiring wire-body comprises:
a sheet-like first portion; and
a second portion which fixes the first portion to the first member or the second member,
wherein the first portion is arranged in the hollow portion so as to partition a space in the hollow portion into two small spaces or more in a direction crossing the axis line, and
wherein each of the partitioned small spaces is configured to allow the one or more of the wire-bodies to pass therethrough.

2. The member for wiring wire-body according to claim 1, wherein the member for wiring wire-body is made of a flexible material.

3. The member for wiring wire-body according to claim 1, wherein the first portion is formed into a cylindrical shape surrounding the one or more wire-bodies with a space so as to define the small spaces inside and outside the first portion.

4. The member for wiring wire-body according claim 3, wherein the first portion has a flat and open shape and is formed into a cylindrical shape by rolling the first portion in one direction and binding the both ends.

5. The member for wiring wire-body according to claim 1, wherein the second portion is fixed to a portion located outside the hollow portion.

6. The member for wiring wire-body according to claim 1, wherein the second portion is fixed to a position located above the hollow portion arranged in a vertical direction,
and the member for wiring wire-body further comprises a third portion at a position located between the first portion and the second portion, and the first portion is suspended by the third portion so that the first portion is movable in a horizontal direction.

7. The member for wiring wire-body according to claim 6, wherein the third portion is formed in a belt shape, and
the first portion, the second portion, and the third portion are formed integrally by cutting out them from a single sheet-like material.

8. The member for wiring wire-body according to claim 1, wherein at least the first portion is made of a low friction material.

9. A structure for wiring wire-body, wherein the structure is used for wiring a plurality of wire bodies at a position between a first member and a second member which rotates relative to each other about a predetermined axis line, and one sides in a length direction of the wire-bodies are held by the first member and the other sides are held by the second member, wherein the structure for wiring wire-body comprises:
a hollow member which has a hollow portion arranged along the axis line and which is fixed to the first member or the second member; and
a member for wiring wire-body,
wherein the member for wiring wire-body comprises:
a sheet-like first portion arranged at a position in the hollow portion; and
a second portion which fixes the first portion to the first member or the second member,
wherein the first portion is arranged in the hollow portion so as to partition a space in the hollow portion into two small spaces or more in a direction crossing the axis line, and
wherein each of the partitioned small spaces is configured to allow the one or more of the wire-bodies to pass therethrough.

10. A method of wiring work for wire-body, wherein the method is for wiring a plurality of wire bodies penetrating a hollow portion arranged between a first member and a second member which rotate relative to each other about a predetermined axis line, the hollow portion is arranged along the predetermined axis line, and one sides in a length direction of the wire-bodies are held by the first member and the other sides are held by the second member, wherein the method comprises
partitioning a space in the hollow portion into two small spaces or more in a direction crossing the axis line by means of a sheet-like member, wherein each of the partitioned small spaces is configured to allow the one or more of the wire bodies to pass therethrough.
